(19) United States
(12) Patent Application Publication
(10) Pub. No.: US 2020/0220214 A1
(43) Pub. Date: Jul. 9, 2020

(54) POLY ETHYLENE OXIDE (PEO) - POLYHEDRAL OLIGOMERIC SILSESQUIOXANE (POSS) BASED POLYMER ELECTROLYTE

(71) Applicant: The Regents of the University of California, Oakland, CA (US)

(72) Inventors: Irune Villaluenga, Kensington, CA (US); Gurmukh K. Sethi, Berkeley, CA (US); Nitash P. Balsara, El Cerrito, CA (US)

(73) Assignee: THE REGENTS OF THE UNIVERSITY OF CALIFORNIA, Oakland, CA (US)

(21) Appl. No.: 16/735,277

(22) Filed: Jan. 6, 2020

Related U.S. Application Data
(60) Provisional application No. 62/788,560, filed on Jan. 4, 2019.

(51) Int. Cl. H01M 10/0565; H01M 10/0525; C08G 81/02

(52) U.S. Cl. CPC H01M 10/0565; H01M 10/0525; H01M 2300/0028; H01M 2300/0082; C08G 81/025

(57) ABSTRACT

A polymer electrolyte is disclosed, the polymer electrolyte includes a poly ethylene oxide (PEO)-acrylate chain comprising a plurality of ethylene oxide molecules. The PEO-acrylate chain is linked to a polyhedral oligomeric silsesquioxane (POSS) chain comprising a plurality of POSS molecules, thereby forming a block copolymer. The polymer electrolyte also includes salt molecules, the concentration of which may change the ionic conductivity of the polymer electrolyte.

### CROSS REFERENCE TO RELATED APPLICATIONS

This application claims priority to U.S. Provisional Patent Application Ser. No. 62/788,560, filed Jan. 4, 2019.

### STATEMENT OF GOVERNMENTAL SUPPORT

The invention was made with government support under Contract No. DE-ACO2-05CH11231 awarded by the U.S. Department of Energy. The government has certain rights in the invention.

### TECHNICAL FIELD

Aspects of the present disclosure relate to block copolymers, and more particularly, to polymer electrolytes.

### BACKGROUND

Block copolymers are materials that have 2 disparate phases that both coexist on a small length scale (e.g., ˜10 nm). One example of a block copolymer is a polymer electrolyte. Polymer electrolytes contain a soft ion conducting domain, as well as a rigid non-conducting domain, thereby allowing both mechanical and electrical properties to be tuned separately. Such materials find useful application in lithium ion batteries for example, where current must be carried (e.g. from the anode to the cathode and vice versa). Currently, most block copolymer electrolytes comprise organic polymer chains for both the conducting and rigid domains.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a diagram that illustrates an example molecular structure of a polymer electrolyte, in accordance with some embodiments of the present disclosure.

FIG. 2 is a graph that illustrates the relationship between ionic conductivity and salt concentration of the polymer electrolyte of FIG. 1, in accordance with some embodiments of the present disclosure.

FIG. 3 is a flow diagram of a method for synthesizing the polymer electrolyte of FIG. 1 in accordance with some embodiments of the present disclosure.

FIGS. 4A and 4B are graphs illustrating the relationship between the shear moduli (rigidity) and angular frequency and loss moduli and angular frequency respectively of the polymer electrolyte of FIG. 1, in accordance with some embodiments of the present disclosure.

FIG. 5 is a block diagram illustrating a battery in accordance with some embodiments of the present disclosure.

FIGS. 6A and 6B are graphs illustrating the scattering intensity of a PEO-POSS electrolyte as a function of magnitude of the scattering vector, in accordance with some embodiments of the present disclosure.

FIG. 7 is a graph illustrating the scattering intensity of PEO-POSS/LiTFSI mixtures over various salt concentrations, in accordance with some embodiments of the present disclosure.

FIG. 8 is a diagram illustrating the morphology of phases on a temperature versus salt concentration plot, in accordance with some embodiments of the present disclosure.

FIGS. 9A and 9B are HAADF-STEM micrographs of stained PEO-POSS electrolytes, in accordance with some embodiments of the present disclosure.

FIG. 9C illustrates SAXS scattering profiles, in accordance with some embodiments of the present disclosure.

FIGS. 10A-10E are electron tomography of PEO-POSS electrolyte, in accordance with various embodiments of the present disclosure.

### DETAILED DESCRIPTION

As discussed above, lithium ion batteries require current to be carried between the anode and the cathode. In traditional lithium ion cells, current is often carried by liquid electrolytes, which are flammable, unstable solvents. Certain solid polymer electrolytes are available, which contain a soft ion conducting domain, as well as a rigid non-conducting domain, thereby allowing both mechanical and electrical properties to be tuned separately. However solid polymer electrolytes do not provide the conductivity that liquid electrolytes do. The mechanical part of a polymer electrolyte may be strengthened by the addition of polyhedral oligomeric silsesquioxane (POSS) molecules onto the rigid domain of a solid polymer electrolyte. However, POSS molecules on their own are limited in how much they can improve the conductivity, mechanical properties, internal flexibility and other performance factors of solid polymer electrolytes.

The present disclosure addresses the above-noted and other deficiencies by disclosing a polymer electrolyte comprising a POSS molecule chain and poly ethylene oxide (PEO) molecule chain covalently combined to form a block copolymer. The polymer electrolyte may also include salt, the concentration of which may affect the ionic conductivity of the polymer electrolyte.

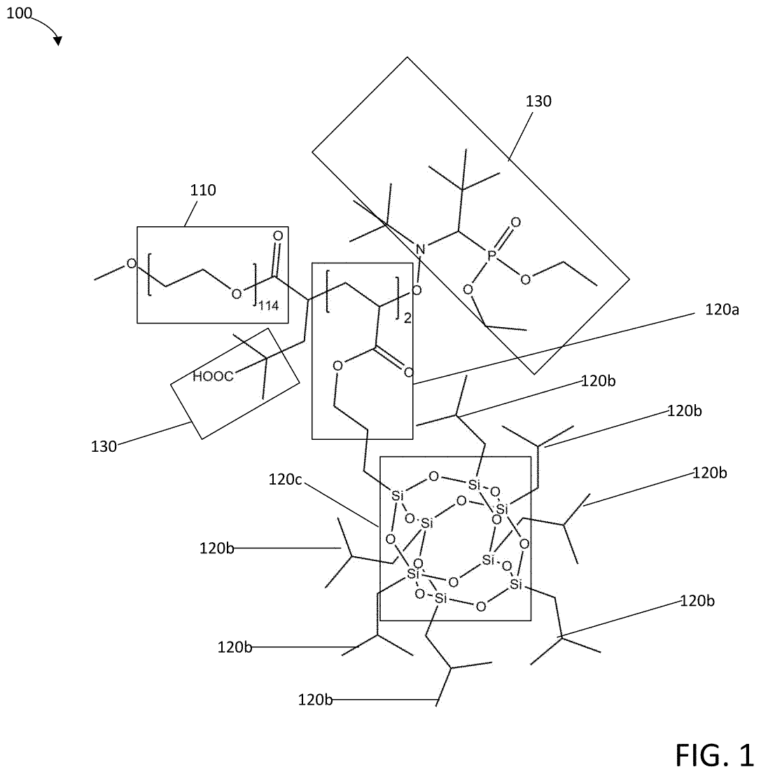

FIG. 1 illustrates the chemical structure of a composition 100, in accordance with some embodiments of the present disclosure. Composition 100 may be a polymer electrolyte. Composition 100 may include a PEO-acrylate chain having a plurality of PEO-acrylate molecules and a POSS-acryloisobutyl chain, having a plurality of POSS-acryloisobutyl molecules. However, for ease of illustration a single PEO-acrylate molecule 110 and a single POSS-acryloisobutyl molecule 120a-c are shown in FIG. 1. The PEO-acrylate molecule 110 may comprise an ethylene oxide molecule and an acrylate functional group (not shown in the Figures). As shown in FIG. 1, POSS-acryloisobutyl molecule 120a-c comprises a polymerizable monomer 120a with a pendant POSS unit 120c which is attached to seven functional groups 120b (as shown in FIG. 1). As illustrated in FIG. 1, the polymerizable monomer 120a is an acrylate polymerizable monomer and the functional groups 120b are isobutyl functional groups. However, other polymerizable monomers such as methacrylate, styrene, dimethylacrylamide, maleic anhydride, and 2-acrylamido-2-methylpropanesulfonic acid may also be used. In addition, the seven functional groups may be any appropriate functional group such as phenyl, isobutyl, octyl, ethyl, and benzenesulfonic acid. Anionic polymerization or different controlled radical polymerizations may be used to synthesize PEO-POSS block copolymers such as atom transfer radical polymerization (ATRP), nitroxide-mediated radical polymerization (NMP), and reversible addition fragmentation chain transfer (RAFT) polymerization as discussed in further detail below.

The PEO-acrylate chain may have a macro-initiator chain attached to it, thereby forming a PEO-based macro-initiator chain as discussed further herein. The molecules in the macro-initiator chain may be any appropriate macro-initiator molecule, such as alkoxyamine. The embodiments of the present disclosure are described with respect to alkoxyamine by example only, and any suitable macro-initiator may be used. FIG. 1 illustrates an alkoxyamine molecule 130, which may be part of a larger alkoxyamine initiator chain and may serve as a link for connecting PEO-acrylate molecule 110 and POSS-acryloisobutyl molecule 120a-c. More specifically, the alkoxyamine molecule 130 may break down into a methacrylic acid-based radical initiating species (initiator) and a nitroxide-based reaction controller. The initiator reacts with the acrylate functional group of The PEO-acrylate molecule 110, and this yields a PEO-based alkoxyamine initiator chain that acts as an initiator, allowing a controlled polymerization (molecular weight, polydispersity, and copolymer sequencing) of POSS-acryloisobutyl molecule 120a-c by a covalent bond with PEO-acrylate molecule 110. In this way, the alkoxyamine initiator chain may connect the PEO-acrylate chain and the POSS-acryloisobutyl chain.

The combined PEO-acrylate chain and the POSS-acryloisobutyl chain may form a block copolymer. The PEO-acrylate molecule 110 may function to dissolve salt and conduct ions. Composition 100 may further include salt (not shown in the Figures), in a range of concentrations as discussed herein. More specifically, composition 100 may include lithium salts such as lithium perchlorate (LiClO4), lithium hexafluorophosphate (LiPF6) bis (trifluoromethane) sulfonamide (LiTFSI), and other lithium salts that are commonly used as ion conductors in lithium batteries, and combinations thereof, mixed into the block copolymer. This may result in polymer electrolytes having higher conductivity, ridigity (shear modulus) and other beneficial properties as discussed herein.

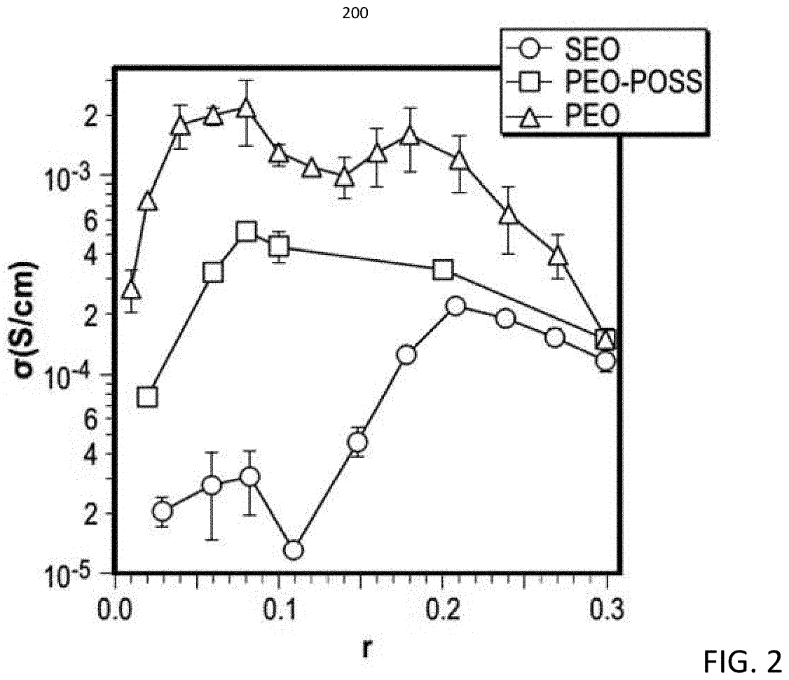

The molecular weights of the PEO-acrylate chain and the POSS-acryloisobutyl chain in composition 100 may be 1-300 kilograms per mole (kg/mol) and 1-300 kg/mol respectively. In some embodiments, molecular weights of the PEO-acrylate chain and the POSS-acryloisobutyl chain in composition 100 may be 5 kg/mol and 2 kg/mol respectively. The ionic conductivity of the polymer electrolyte may be based, at least in part, on the concentration of salt molecules relative to the concentration of ethylene oxide molecules in composition 100. FIG. 2 illustrates a graph 200 of the ionic conductivity (σ) of composition 100 plotted against the salt concentration (r) for the composition 100. The salt concentration “r” is equal to the ratio of mols of salt to mols of ethylene oxide in composition 100. As indicated in FIG. 2, the concentration of salt within composition 100 need not be high in order to effect a change in the conductivity of composition 100. For example, a small amount of salt (e.g., 0.02 mols of salt per mol of ethylene oxide monomers) may fundamentally change the conductivity of the composition 100.

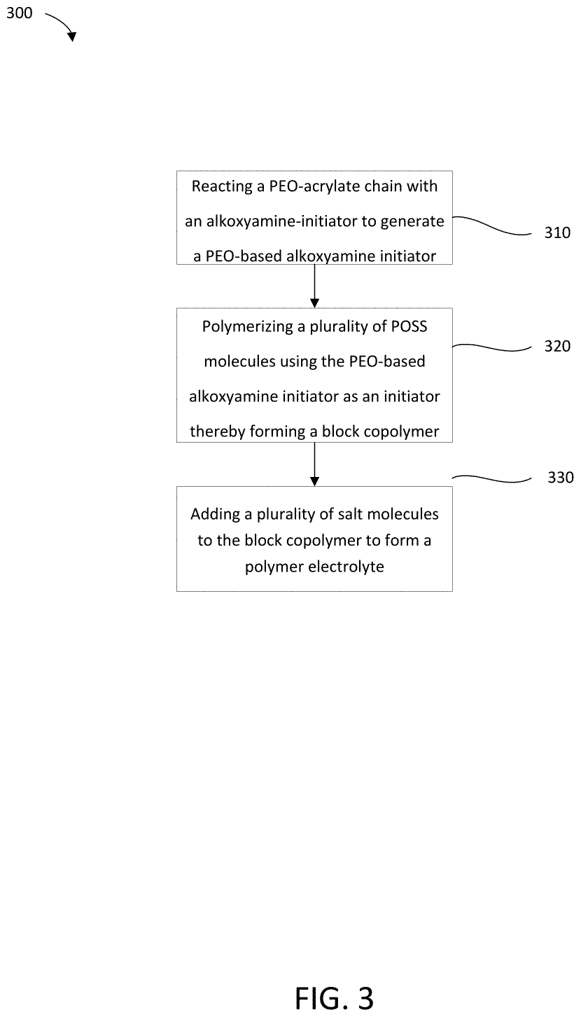

FIG. 3 illustrates a flow diagram of a method 300 for synthesizing a PEO-POSS based polymer electrolyte when using an alkoxyamine initiator. At block 310, PEO-acrylate may be reacted with a macro-initiator to form a PEO-based macro-initiator. More specifically, the macro-initiator may be an alkoxyamine initiator and may be combined with the PEO-acrylate to form a PEO-based alkoxyamine initiator. However, any appropriate macro-initiator may be used. The molecular weight of the PEO-acrylate may be 1-50 kg/mol, and in some embodiments may be 5 kg/mol. The molecular weight of the macro-initiator may depend on the type of macro-initiator used. In some embodiments, the macro-initiator may be alkoxyamine initiator and the molecular weight may range from 25-100 kg/mol. In some embodiments, the molecular weight of the alkoxyamine initiator may be 50 kg/mol. The alkoxyamine initiator may be used as a building block to promote controlled polymerization and may serve as a link for connecting a PEO-acrylate chain with a POSS molecule chain. The concentration of the PEO-based alkoxyamine initiator may be used to control the length and weight of the POSS molecule chain. The alkoxyamine-initiator and the PEO-acrylate may be combined within a solvent, such as anhydrous ethanol, that may promote dissolving of the alkoxyamine initiator and PEO-acrylate, thereby facilitating the combination process. In some embodiments, the solvent may be an organic solvent. The solvent may be heated to 90-105 degrees Celsius to allow alkoxyamine-initiator molecules to react with the PEO-acrylate molecules. More specifically, alkoxyamine-initiator molecules may find the functional groups of the PEO-acrylate molecules and chemically attach to the PEO-acrylate molecules via the functional groups. In some embodiments, the solvent may be heated to 100 degrees Celsius. The alkoxyamine initiator and the PEO-acrylate may be combined in the solvent for 2-12 hours, resulting in a PEO-based alkoxyamine initiator. In some embodiments, the alkoxyamine-initiator and the PEO-acrylate may be combined in the solvent for 4 hours. In some embodiments, the alkoxyamine initiator and the PEO-acrylate may be combined in the solvent under Argon, thereby ensuring that the combination process takes place in an air free environment. It should be noted that the molecules in the PEO-acrylate may already be structured as a chain prior to the combination, such that upon combination with the alkoxyamine initiator, a PEO-based alkoxyamine initiator chain is formed. The PEO-based alkoxyamine initiator may be isolated from the solvent using precipitation in a separate organic solvent, such as cold diethyl ether.

Referring to FIG. 1, POSS molecules comprise a polymerizable monomer 120a with a pendant POSS unit 120c which is attached to seven functional groups 120b. The polymerizable monomer 120a is an acrylate polymerizable monomer and the functional groups 120b are isobutyl functional groups. However, other polymerizable monomers such as methacrylate, styrene, dimethylacrylamide, maleic anhydride, and 2-acrylamido-2-methylpropanesulfonic acid may also be used. In addition, the seven functional groups may be any appropriate functional group such as phenyl, isobutyl, octyl, ethyl, and benzenesulfonic acid. Anionic polymerization or different controlled radical polymerizations may be used to synthesize PEO-POSS block copolymers such as atom transfer radical polymerization (ATRP), nitroxide-mediated radical polymerization (NMP), and reversible addition fragmentation chain transfer (RAFT) polymerization.

Referring back to FIG. 3, at block 320, a plurality of POSS molecules may be radically polymerized, using the PEO-based alkoxyamine initiator as an initiator. The molecular weight of the plurality of POSS molecules may be from 1 kg/mol to 50 kg/mol. More specifically, the plurality of POSS molecules may be combined with the PEO-based alkoxyamine initiator in a solvent such as anhydrous xylene which may facilitate the polymerization process. In some embodiments, the solvent may be an organic solvent. The solvent may be heated to 90-125 degrees Celsius and the POSS molecules may be allowed to polymerize for 2 hours to 5 days. In some embodiments, the solvent may be heated to 115 degrees Celsius and the POSS molecules may be allowed to polymerize at for 24 hours. During this time, the PEO-based alkoxyamine initiator may function as an initiator, and allow POSS molecules to form covalent bonds with the alkoxyamine molecules in the PEO-based alkoxyamine initiator as well as other POSS molecules. This may result in connecting the POSS chain with the PEO-acrylate chain thereby forming a block copolymer. The block copolymer may be isolated by precipitation in an organic solvent such as cold diethyl ether and then subjected to centrifugation at 1000-10000 revolutions per minute (rpm) for 2-30 minutes. In some embodiments, the block copolymer may be subject to centrifugation at 6500 rpm for 10 minutes. The isolation and centrifugation process may be repeated until a desired consistency is reached.

At block 330, salt molecules may be mixed into the block copolymer, resulting in a polymer electrolyte having soft ion conducting domains and rigid non-conducting domains. More specifically, lithium bis (trifluoromethane) sulfonamide (LiTFSI) salt may be mixed into the block copolymer. As discussed above, the ionic conductivity of the polymer electrolyte may be based, at least in part, on the concentration of salt molecules in the block copolymer, which is given as mols of salt molecules per mols of ethylene oxide molecules.

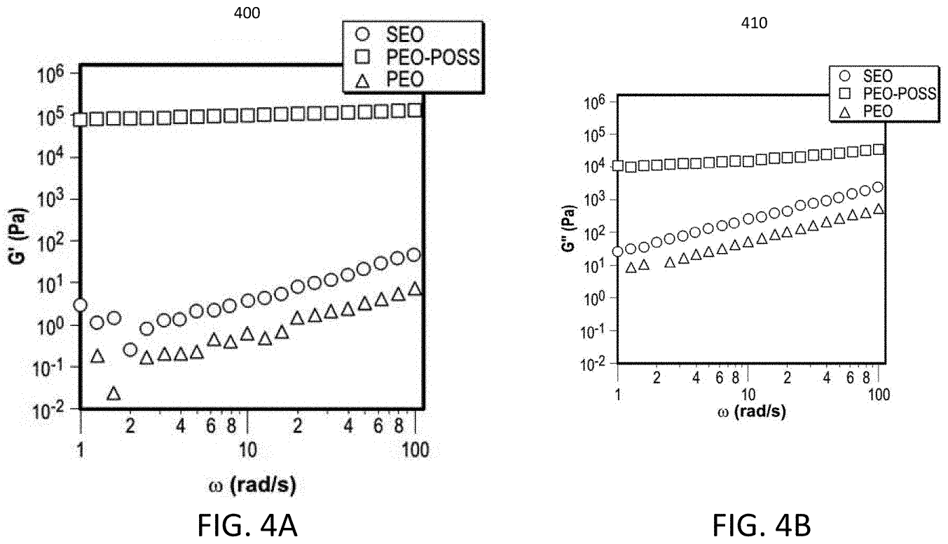

FIG. 4A illustrates a graph 400 of the shear moduli (i.e. rigidity—shown as G′) against the angular frequency (w) of the PEO-POSS neat block copolymer (composition 100 without the salt). As illustrated in FIG. 4A, the composition 100 has a shear moduli that is approximately 5 orders of magnitude higher than single ethylene oxide (SEO) or PEO (homopolymer)-based neat polymers across all frequency values. In addition, the shear moduli of composition 100 is more consistent across the range of frequencies than either the SEO or the PEO-based neat polymers. FIG. 4B illustrates a graph 410 of the loss moduli (G″) against angular frequency (ω) of the PEO-POSS neat block copolymer (composition 100 without the salt). Again, the PEO-POSS block copolymer has higher loss moduli and is more consistent across the range of angular frequencies.

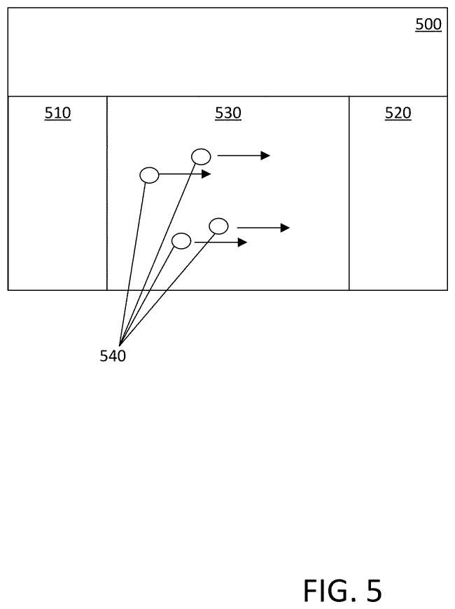

FIG. 5 illustrates a battery 500, in accordance with some embodiments of the present disclosure. Battery 500 may be a lithium ion battery, for example. Battery 500 may include an anode 510, a cathode 520, and an electrolyte 530 to transport ions 540 between the two. In some embodiments, the ions may be lithium ions. In some embodiments, the anode 510 may comprise active materials such as graphite, silicon, and other active materials. In some embodiments, anode 510 may comprise lithium metal. In some embodiments, the cathode 520 may comprise active materials such as lithium cobalt oxide (LiCoO2), lithium iron phosphate (LiFePO4), lithium sulfide (Li2S), elemental sulfur, lithium nickel manganese cobalt oxide (NMC), and other active materials. The electrolyte 530 may comprise the polymer electrolyte described with respect to FIG. 1. During a discharge for example, ions 540 carry the current within the battery from the anode 510 to the cathode 520, through the electrolyte 530 and a separator diaphragm (not shown in the Figures) Similarly, during charging, an external electrical power source (not shown in the Figures) applies an over-voltage (a higher voltage than the battery produces, of the same polarity), which may force a charging current to flow within the battery from the cathode 520 to the anode 510, i.e. in the reverse direction of a discharge current under normal conditions. The ions 540 may then migrate from the cathode 520 to the anode 510, where they become embedded in the porous electrode material. Thus, the speed at which ions travel across the electrolyte 530 and within anode 510 and cathode 520 plays a large role in how much time it takes to charge and discharge battery 500. As discussed above with respect to FIGS. 2, 4A and 4B, the ionic conductivity and other properties of the PEO-POSS based polymer electrolyte described herein may thus facilitate faster charging and discharging. The high ionic conductivity, increased shear moduli and internal flexibility may allow for increased battery performance in a number of aspects.

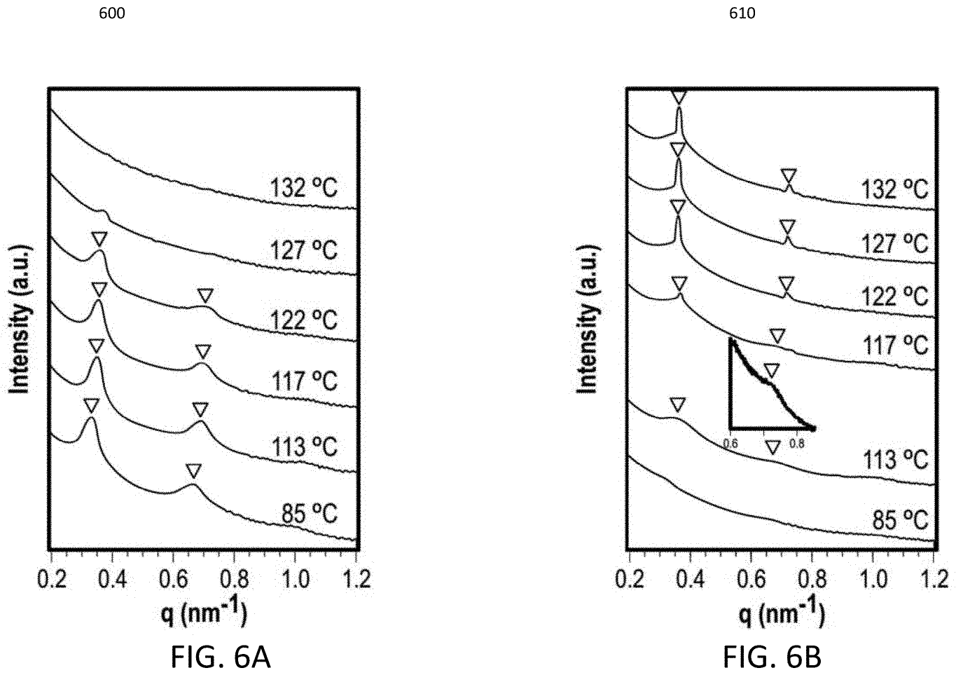

FIGS. 6A and 6B are graphs illustrating the scattering intensity of PEO-POSS as a function of magnitude of the scattering vector over various temperatures. FIG. 6A shows graph 600 which illustrates the scattering intensity of PEO-POSS block copolymer (neat polymer—i.e. no salt added) over various temperatures. At 85° C. we obtain a primary scattering peak at q=q*=0.32 nm⁻¹ and a second order scattering peak at 2q*. This is a standard signature of a lamellar phase. The center-to-center distance between adjacent PEO lamellae, d, given by d=2π/q*, is 19.6 nm. This morphology persists until 122° C. At 127° C., the intensity of the primary scattering peak diminishes significantly and the second order peak disappears. This SAXS profile indicates the presence of disordered concentration fluctuations. It is evident that neat PEO-POSS exhibits an order-to-disorder transition upon heating at 125±3° C. This behavior, that is qualitatively similar to that of most organic block copolymers, suggests that PEO and POSS chains exhibit repulsive interactions.²⁰⁻²² At low temperatures, these interactions dominate, leading to an ordered phase. At high temperatures entropic effects dominate, leading to mixing of PEO and POSS segments. The estimated Flory-Huggins interaction parameter, based on a reference volume of 0.1 nm³, at 125° C. is 0.18 using a diblock copolymer phase diagram.

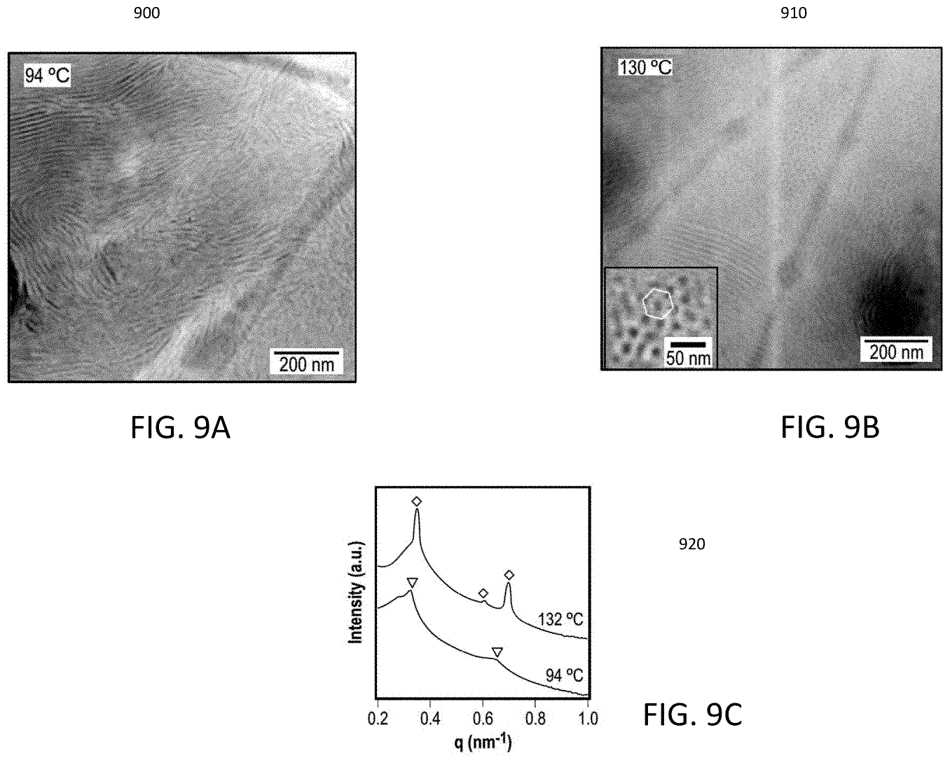

FIG. 6B shows graph 610 which illustrates the scattering intensity of PEO-POSS polymer electrolyte with a salt concentration (r) of 0.02 over various temperatures. The SAXS profiles obtained from a PEO-POSS/LiTFSI mixture with r=0.02 are shown in FIG. 9C. At 85° C., I is a monotonically decaying function of q, qualitatively similar to the 132° C. data obtained from neat PEO-POSS. We therefore conclude that the r=0.02 sample is disordered at this temperature. Increasing the temperature to 113° C. results in broad SAXS peaks at q=q*=0.33 nm⁻¹ and at q=2q*; see inset in FIG. 6B. The emergence of the higher order peak is taken to be a signature of the disorder-to-order transition (there is a hint of a broad peak at q=3q* in the 113° C. data in FIG. 6B). Disorder-to-order transitions upon heating have been reported in several neat diblock copolymer systems.24-30 Increasing the temperature further to 117° C. results in the appearance of sharp peaks at q=q*=0.35 nm⁻¹ and at 2q*. The SAXS profile at 122° C. and above are characteristic of a well-ordered lamellar phase.

The scattering peaks obtained from the lamellar phase at r=0.02 are significantly sharper than those seen in the neat copolymer (compare the 85° C. scattering profile in FIG. 6A with 132° C. scattering profile in FIG. 6B). This observation indicates that the high temperature ordered phase obtained in the salt-containing PEO-POSS sample exhibits better long-range order than the low temperature ordered phase in neat PEO-POSS. Whether this is due to the presence of salt or the annealing of defects at higher temperature is unclear at this juncture. The primary scattering peak at 117° C. appears to be a superposition of the broad peak seen at 113° C. and the sharp peak seen at 122° C. The superposition may also be due to the presence of two coexisting ordered phases with different salt concentrations.³¹

It is well-known that, if salt interacts exclusively with the PEO block, one observes stabilization of the ordered phase.³²⁻³⁸ In contrast, in salt-containing PEO-POSS at temperatures below 97° C., the addition of salt stabilizes the disordered phase. The data in FIG. 1 suggests that the salt molecules interact with both PEO and POSS segments. While further work is needed to identify the nature of these interactions, they are strong enough to cause mixing between chains that are immiscible without salt. At sufficiently high temperatures, entropic contributions dominate, the relative importance of specific interactions diminishes, and PEO and POSS segments form separate domains.

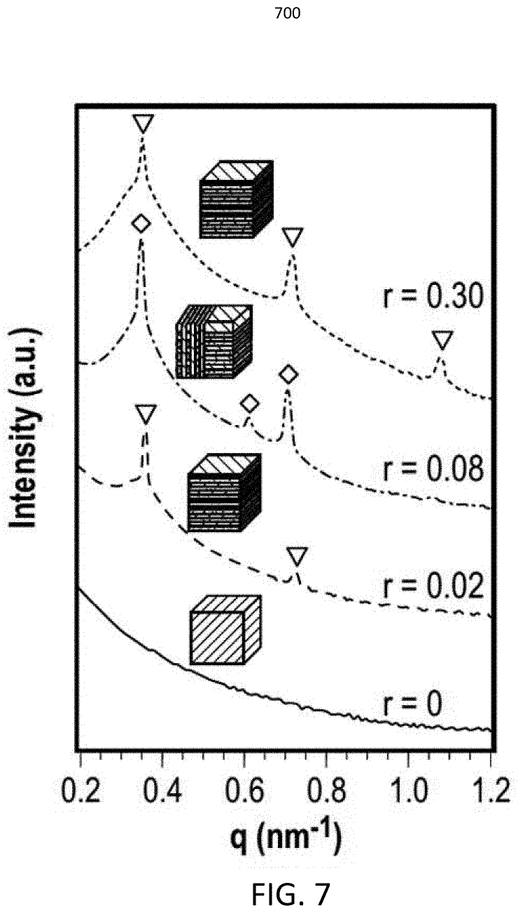

The effect of added salt on the morphology of PEO-POSS electrolytes is shown in graph 700 of FIG. 7 for a range of salt concentrations at 132° C. The neat sample is disordered at this temperature, while all salt containing samples are ordered. At low salt concentration, r=0.02, a lamellar phase is obtained. Increasing the salt concentration to r=0.08 results in the emergence of an additional scattering peak at q=3 q* that is superimposed on the scattering profile of the lamellar phase. This peak is a signature of a hexagonally packed cylinders morphology. Increasing salt concentration further to r=0.30 results in a reentrant lamellar phase.

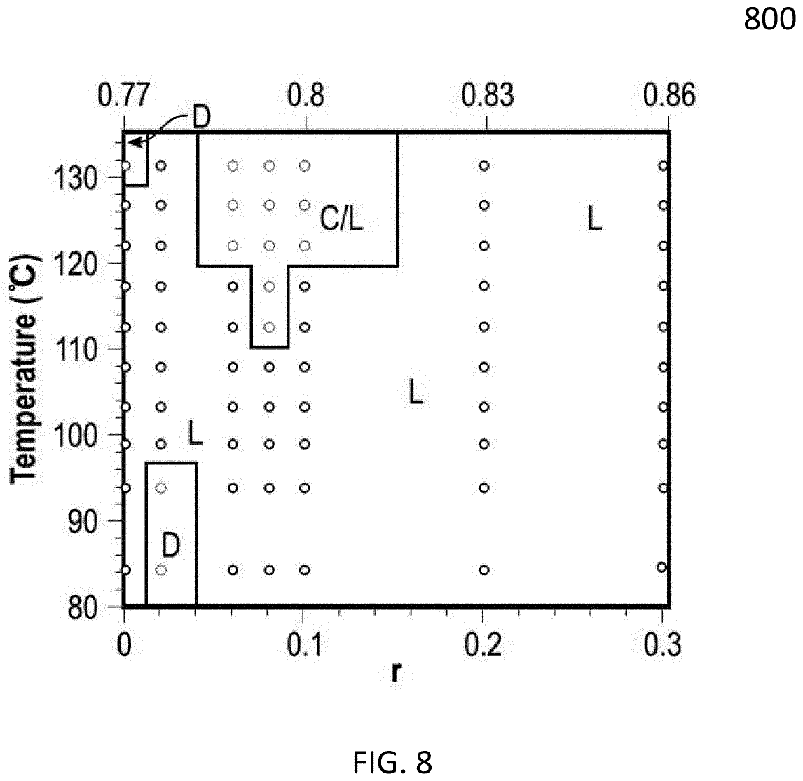

FIG. 8 summarizes the results of the SAXS experiments, where the morphologies of PEO-POSS/LiTFSI mixtures are shown as a function of temperature and salt concentration in graph 800. The lamellar (L) phase dominates the phase diagram which contains isolated pockets of disordered (D) and coexisting cylinders/lamellae (C/L). This is surprising given _{EO} is 0.77. Determining the distribution of salt in the two coexisting microphases is beyond the scope of this study. Using the assumption that is standard in the field of block copolymer electrolytes that LiTFSI resides exclusively in the PEO domains,^{35,39,40} the estimated volume fraction of the PEO-rich phase increases with salt addition to EO=0.86 at r=0.30. This estimated volume fraction is shown as the secondary (top) x-axis in FIG. 8. The geometry of ordered phases in conventional block copolymers depends mainly on the volume fraction of one of the blocks.^{41,42} Increasing the volume fraction of the major component is expected to stabilize either cylinders or spheres, not lamellae.^{22,43} If this were true in PEO-POSS, cylinders would emerge at high salt concentration. Clearly, this is not the case. The sample with EO=0.86 exhibits a lamellar morphology over the entire accessible temperature window. Cylinders are only seen at high temperatures in a limited window (0.06≤r≤0.1). We posit that the specific interactions between salt, PEO, and POSS that stabilize the disordered phase in the dilute electrolyte are also responsible for the unexpected stabilization of the lamellar phase. At high temperatures, the importance of these interactions diminishes, leading to the formation of the expected cylinder phase. We note that the Gibbs phase rule requires coexistence at all phase boundaries in FIG. 3. This suggests the presence of a pure cylinder phase at temperatures above 132° C.

FIGS. 9A and 9B shows ordered phases. Two samples of the r=0.08 electrolyte were annealed at 94 and 130° C. and quenched in liquid nitrogen to “freeze” the morphology at these temperatures. The resulting micrographs, obtained by high-angle annular dark-field scanning transmission electron microscopy (HAADF-STEM) are shown in FIG. 9A (900) and FIG. 9B (910) where the bright phase represents the RuO₄ stained PEO-rich microphases. The micrograph obtained from the 94° C. sample shows alternating dark and bright stripes representing the lamellar phase. The micrograph obtained from the 130° C. sample shows both dark spots arranged on a hexagonal lattice (FIG. 9B), confirming the presence of POSS-rich cylinders in a PEO-rich matrix, and alternating POSS-rich and PEO-rich stripes.

Two samples of the r=0.08 electrolyte were annealed at 94 and 130° C. and quenched in liquid nitrogen to “freeze” the morphology at these temperatures. The resulting micrographs, obtained by high-angle annular dark-field scanning transmission electron microscopy (HAADF-STEM) are shown in FIG. 9A and FIG. 9B where the bright phase represents the RuO₄ stained PEO-rich microphases. The micrograph obtained from the 94° C. sample shows alternating dark and bright stripes representing the lamellar phase. The micrograph obtained from the 130° C. sample shows both dark spots arranged on a hexagonal lattice, confirming the presence of POSS-rich cylinders in a PEO-rich matrix, and alternating POSS-rich and PEO-rich stripes. FIG. 9C shows SAXS scattering profiles 920 taken at 94° C., with scattering peaks indicative of a lamellar morphology indicated by triangles, and 132° C. with scattering peaks denoted by diamonds indicating coexisting cylinders and lamellae.

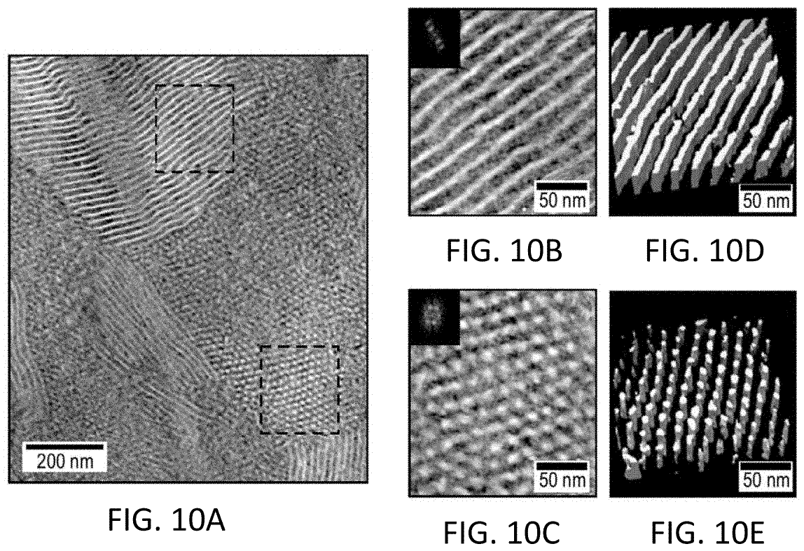

To confirm that the stripes seen in FIG. 9B correspond to a lamellar phase as opposed to cylinders lying in the sample plane, electron tomography of the r=0.08 electrolyte annealed at 130° C. was utilized, and the results are shown in FIGS. 10A to 10E. FIG. 10A shows a slice of the tomogram where POSS is the bright phase and PEO is the dark phase. Bright spots arranged in a hexagonal lattice imply POSS rich-cylinders and alternating bright and dark stripes indicate lamellae. FIGS. 10B and 10C are magnifications of the outlined boxes in FIG. 10A that depict the lamellar and cylindrical morphology, respectively. Fourier transforms of the real-space images are also provided to confirm these lattice arrangements. FIG. 10D is a 3D representation of the POSS-rich phase of the tomogram shown in FIG. 10B. It indicates the presence of lamellae. Similarly, FIG. 10E, which is a 3D representation of FIG. 10C, shows the presence of POSS-rich cylinders. Thus, the coexistence of lamellae and cylinders is confirmed by both SAXS and electron tomography.

The transport of lithium ions in polymers is facilitated by the segmental motion which is rapid in soft polymers such as amorphous PEO.⁴⁷ The goal of creating block copolymer electrolytes is to increase the modulus of the electrolyte while minimizing the decrease in ionic conductivity due to the presence of nonconducting domains. The ionic conductivity of PEO-POSS electrolytes is plotted as a function of salt concentration at 90° C. in FIG. 2. The electrolytes have a lamellar morphology at all values of r except r=0.02, where it forms a disordered phase. Also shown in FIG. 6A is the conductivity of homopolymer PEO electrolyte with a molecular weight of 5 kg mol⁻¹ and that of a conventional polystyrene-b-poly(ethylene oxide) (SEO) electrolyte with molecular weights of 5 kg mol⁻¹ of both blocks (ϕ_{EO}=0.52).³² We chose this SEO copolymer because it has the same molecular weight for the conducting block and exhibits a lamellar morphology.⁴⁴ Both SEO and PEO-POSS electrolytes exhibit lower conductivities than PEO electrolyte, as expected. However, in the dilute limit, the conductivity of PEO-POSS electrolytes are much higher than that of SEO, by factors ranging from 2 to 10.

The rheological properties of PEO-POSS, PEO (20 kg mol⁻¹), and SEO are shown in FIGS. 4A and 4B at 90° C. (The modulus of PEO (5 kg mol⁻¹) was below the dynamic range of our rheological instrument.) We only present data obtained from the neat polymers due to the hygroscopic nature of the salt-containing electrolytes. The low frequency storage modulus (G′) of SEO is about a factor of 10 higher than PEO, while the loss modulus (G″) is about a factor of 5 higher. Both G′ and G″ of SEO and PEO decrease rapidly with decreasing frequency. In contrast, G′ of PEO-POSS is nearly independent of frequency, while G″ decreases slightly in the frequency range studied. The G′ of PEO-POSS at low frequency (ω=1 rad/s) is a factor of 10⁵ higher than SEO, while G″ is over a factor of 10² higher than SEO.

In summary, PEO-POSS represents a new platform for creating self-assembled hybrid electrolytes for lithium batteries. In the absence of salt, PEO-POSS presents a classical order-to-disorder transition upon heating. The addition of salt at low concentration results in a disorder-to-order transition upon heating. Further increase in salt concentration results in the stabilization of ordered phases. In conventional block copolymers, spherical or cylindrical morphologies are expected when the volume fraction of the major phase is between 0.77 and 0.86. In PEO-POSS, we primarily obtain lamellar phases. The cylindrical morphology is only stable at high temperatures and intermediate salt concentrations. The ionic conductivity of lamellar PEO-POSS electrolytes is higher than that of SEO at all salt concentrations at 90° C.; at r=0.10, the conductivity of PEO-POSS is 50× higher than that of SEO. The low frequency G′ of PEO-POSS is 5 orders of magnitude higher than that of SEO. Further work on optimizing the properties of organic-inorganic hybrid block copolymers for use in all-solid lithium batteries seems warranted.

The methods and illustrative examples described herein are not inherently related to any particular computer or other apparatus. Various general purpose systems may be used in accordance with the teachings described herein, or it may prove convenient to construct more specialized apparatus to perform the required method steps.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

### REFERENCES

Fenton, D. E.; Parker, J. M.; Wright, P. V. Complexes of alkali metal ions with poly(ethylene oxide). Polymer 1973, 14, 589.
Berthier, C.; Gorecki, W.; Minier, M.; Armand, M. B.; Chabagno, J. M.; Rigaud, P. Microscopic investigation of ionic conductivity in alkali metal salts-poly(ethylene oxide) adducts. Solid State Ionics 1983, 11, 91-95.
Bouchet, R.; Maria, S.; Meziane, R.; Aboulaich, A.; Lienafa, L.; Bonnet, J. P.; Phan, T. N. T.; Bertin, D.; Gigmes, D.; Devaux, D.; Denoyel, R.; Armand, M. Single-ion BAB triblock copolymers as highly efficient electrolytes for lithium-metal batteries. Nat. Mater. 2013, 12, 452-457.
Armand, M.; Tarascon, J. M. Building better batteries. Nature 2008, 451, 652-657.
Devaux, D.; Glé, D.; Phan, T. N. T.; Gigmes, D.; Giroud, E.; Deschamps, M.; Denoyel, R.; Bouchet, R. Optimization of Block Copolymer Electrolytes for Lithium Metal Batteries. Chem. Mater. 2015, 27, 4682-4692.
Croce, F.; Appetecchi, G. B.; Persi, L.; Scrosati, B. Nano-composite polymer electrolytes for lithium batteries. Nature 1998, 394, 456-458.
Sing, C. E.; Zwanikken, J. W.; Olvera De La Cruz, M. Electrostatic control of block copolymer morphology. Nat. Mater. 2014, 13, 694-698.
Hirai, T.; Leolukman, M.; Liu, C. C.; Han, E.; Kim, Y. J.; Ishida, Y.; Hayakawa, T.; Kakimoto, M. A.; Nealey, P. F.; Gopalan, P. One-step direct-patterning template utilizing self-assembly of POSS-containing block copolymers. Adv. Mater. 2009, 21, 4334-4338.
Misner, M. J.; Skaff, H.; Emrick, T.; Russell, T. P. Directed deposition of nanoparticles using diblock copolymer templates. Adv. Mater. 2003, 15, 221-224.
Sohn, B. H.; Cohen, R. E. Silver nanocluster formation within microphase-separated block copolymers. Acta Polym. 1996, 47, 340-343.
Zhang, J.; Ma, C.; Liu, J.; Chen, L.; Pan, A.; Wei, W. Solid polymer electrolyte membranes based on organic/inorganic nano-composites with star-shaped structure for high performance lithium ion battery. J. Membr. Sci. 2016, 509, 138-148.
Goseki, R.; Hirai, T.; Ishida, Y; Kakimoto, M. A.; Hayakawa, T. Rapid and reversible morphology control in thin films of poly-(ethylene oxide)-block-POSS-containing poly(methacrylate). Polym. J. 2012, 44, 658-664.
Kim, S. K.; Kim, D. G.; Lee, A.; Sohn, H. S.; Wie, J. J.; Nguyen, N. A.; MacKay, M. E.; Lee, J. C. Organic/inorganic hybrid block copolymer electrolytes with nanoscale ion-conducting channels for lithium ion batteries. Macromolecules 2012, 45, 9347-9356.
Daga, V. K.; Anderson, E. R.; Gido, S. P.; Watkins, J. J. Hydrogen Bond Assisted Assembly of Well-Ordered Polyhedral Oligomeric Silsesquioxane Block Copolymer Composites. Macromolecules 2011, 44, 6793-6799.
Romo-Uribe, A. Viscoelastic Behavior of Unentangled POSS-Styrene Nanocomposites and the Modification of Macromolecular Dynamics. Macromolecules 2017, 50, 7177.
Ayandele, E.; Sarkar, B.; Alexandridis, P. Polyhedral Oligomeric Silsesquioxane (POSS)-Containing Polymer Nanocomposites. Nano-materials 2012, 2, 445-475.
Polu, A. R.; Rhee, H. W. Nanocomposite solid polymer electrolytes based on poly(ethylene oxide)/POSS-PEG (n=13.3) hybrid nanoparticles for lithium ion batteries. J. Ind. Eng. Chem. 2015, 31, 323-329.
Lee, J. Y.; Lee, Y. M.; Bhattacharya, B.; Nho, Y. C.; Park, J. K. Solid polymer electrolytes based on crosslinkable polyoctahedral silsesquioxanes (POSS) for room temperature lithium polymer batteries. J. Solid State Electrochem. 2010, 14, 1445-1449.
Wang, D. K.; Varanasi, S.; Strounina, E.; Hill, D. J. T.; Symons, A. L.; Whittaker, A. K.; Rasoul, F. Synthesis and characterization of a POSS-PEG macromonomer and POSS-PEG-PLA hydrogels for periodontal applications. Biomacromolecules 2014, 15, 666-679.
Sakamoto, N.; Hashimoto, T. Order-Disorder Transition of Low Molecular Weight Polystyrene-block-Polyisoprene. 1. SAXS Analysis of Two Characteristic Temperatures. Macromolecules 1995, 28, 6825-6834.
Leibler, L. Theory of Microphase Separation in Block Copolymers. Macromolecules 1980, 13, 1602-1617.
Fredrickson, G. H.; Helfand, E. Fluctuation effects in the theory of microphase separation in block copolymers. J. Chem. Phys. 1987, 87, 697-705.
Cochran, E. W.; Garcia-Cervera, C. J.; Fredrickson, G. H. Stability of the gyroid phase in diblock copolymers at strong segregation. Macromolecules 2006, 39, 2449-2451.
Russell, T. P.; Karis, T. E.; Gallot, Y.; Mayes, A. M. A lower critical ordering transition in a diblock copolymer melt. Nature 1994, 368, 729-731.
Ruzette, A.-V. G.; Banerjee, P.; Mayes, A. M.; Pollard, M.; Russell, T. P.; Jerome, R.; Slawecki, T.; Hjelm, R.; Thiyagarajan, P. Phase Behavior of Diblock Copolymers between Styrene and n-Alkyl Methacrylates. Macromolecules 1998, 31, 8509-8516.
Karis, T. E.; Russell, T. P.; Gallot, Y.; Mayes, A. M. Rheology of the Lower Critical Ordering Transition. Macromolecules 1995, 28, 1129-1134.
Pollard, M.; Russell, T. P.; Ruzette, A. V.; Mayes, A. M.; Gallot, Y. The effect of hydrostatic pressure on the lower critical ordering transition in diblock copolymers. Macromolecules 1998, 31, 6493-6498.
Ryu, D. Y.; Shin, C.; Cho, J.; Lee, D. H.; Kim, J. K.; Lavery, K. A.; Russell, T. P. Effective interaction parameter for homologous series of deuterated polystyrene-block-poly(n-alkyl methacrylate) copolymers. Macromolecules 2007, 40, 7644-7655.
Yeh, C. L.; Hou, T.; Chen, H. L.; Yeh, L. Y.; Chiu, F. C.; Müller, A. J.; Hadjichristidis, N. Lower critical ordering transition of poly(ethylene oxide)-block-poly(2-vinylpyridine). Macromolecules 2011, 44, 440-443.
Mulhearn, W. D.; Register, R. A. Lower critical ordering transition of an all-hydrocarbon polynorbornene diblock copolymer. ACS Macro Lett. 2017, 6, 808-812.
Loo, W. S.; Jiang, X.; Maslyn, J. A.; Oh, H. J.; Zhu, C.; Downing, K. H.; Balsara, N. P. Reentrant phase behavior and coexistence in asymmetric block copolymer electrolytes. Soft Matter 2018, 14, 2789.
Teran, A. A.; Balsara, N. P. Thermodynamics of block copolymers with and without salt. J. Phys. Chem. B 2014, 118, 4-17.
Young, W. S.; Epps, T. H. Salt doping in PEO-containing block copolymers: Counterion and concentration effects. Macromolecules 2009, 42, 2672-2678.
Gunkel, I.; Thum-Albrecht, T. Thermodynamic and structural changes in ion-containing symmetric diblock copolymers: A small-angle X-ray scattering study. Macromolecules 2012, 45, 283-291.
Nakamura, I.; Wang, Z.-G. Salt-doped block copolymers: ion distribution, domain spacing and effective χ parameter. Soft Matter 2012, 8, 9356.
Mai, S. M.; Fairclough, J. P. A.; Hamley, I. W.; Matsen, M. W.; Denny, R. C.; Liao, B. X.; Booth, C.; Ryan, A. J. Order-disorder transition in poly(oxyethylene)-poly(oxybutylene) diblock copolymers. Macromolecules 1996, 29, 6212-6221.
Qin, J.; De Pablo, J. J. Ordering Transition in Salt-Doped Diblock Copolymers. Macromolecules 2016, 49, 3630-3638.
Schulze, M. W.; McIntosh, L. D.; Hillmyer, M. A.; Lodge, T. P. High-modulus, high-conductivity nanostructured polymer electrolyte membranes via polymerization-induced phase separation. Nano Lett. 2014, 14, 122-126.
Gomez, E. D.; Panday, A.; Feng, E. H.; Chen, V.; Stone, G. M.; Minor, A. M.; Kisielowski, C.; Downing, K. H.; Borodin, O.; Smith, G. D.; Balsara, N. P. Effect of ion distribution on conductivity of block copolymer electrolytes. Nano Lett. 2009, 9, 1212-1216.
Panday, A.; Mullin, S.; Gomez, E. D.; Wanakule, N.; Chen, V. L.; Hexemer, A.; Pople, J.; Balsara, N. P. Effect of molecular weight and salt concentration on conductivity of block copolymer electrolytes. Macromolecules 2009, 42, 4632-4637.
Almdal, K.; koppi, K. A.; Bates, F. S.; Mortensen, K. Multiple Ordered Phases in a Block Copolymer Melt. Macromolecules 1992, 25, 1743-1751.
Hasegawa, H.; Tanaka, H.; Yamasaki, K.; Hashimoto, T. Bicontinuous Microdomain Morphology of Block Copolymers: 1: Tetrapod-Network Structure of Polystyrene-Polyisoprene Diblock Polymers. Macromolecules 1987, 20, 1651-1662.
Bates, F. S.; Fredrickson, G. H. Block copolymers-designer soft materials. Phys. Today 1999, 52, 32-38.
Chintapalli, M.; Le, T. N. P.; Venkatesan, N. R.; Mackay, N. G.; Rojas, A. A.; Thelen, J. L.; Chen, X. C.; Devaux, D.; Balsara, N. P. Structure and Ionic Conductivity of Polystyrene-block-poly(ethylene oxide) Electrolytes in the High Salt Concentration Limit. Macromolecules 2016, 49, 1770-1780.
Pesko, D. M.; Timachova, K.; Bhattacharya, R.; Smith, M. C.; Villaluenga, I.; Newman, J.; Balsara, N. P. Negative Transference Numbers in Poly(ethylene oxide)-Based Electrolytes. J. Electrochem. Soc. 2017, 164, E3569-E3575.
Stone, G. M.; Mullin, S. A.; Teran, A. A.; Hallinan, D. T.; Minor, A. M.; Hexemer, A.; Balsara, N. P. Resolution of the Modulus versus Adhesion Dilemma in Solid Polymer Electrolytes for Rechargeable Lithium Metal Batteries. J. Electrochem. Soc. 2012, 159, A222-A227.
Lascaud, S.; Perrier, M.; Vallée, A.; Besner, S.; Prud'homme, J.; Armand, M. Phase Diagrams and Conductivity Behavior of Poly-(ethylene oxide)-Molten Salt Rubbery Electrolytes. Macromolecules 1994, 27, 7469-7477.

What is claimed is:

1. A polymer electrolyte comprising:
a poly ethylene oxide (PEO)-acrylate chain comprising a plurality of ethylene oxide molecules;
a polyhedral oligomeric silsesquioxane (POSS) chain comprising a plurality of POSS molecules, wherein each of the plurality of POSS molecules is linked to a respective ethylene oxide molecule from the PEO-acrylate chain, thereby forming a block copolymer; and
a plurality of salt molecules.

2. The polymer electrolyte of claim 1, further comprising:
a macro-initiator chain comprising a plurality of macro-initiator molecules, wherein each of the plurality of ethylene oxide molecules is attached to a respective macro-initiator molecule via an acrylate functional group of the ethylene oxide molecule.

3. The polymer electrolyte of claim 2, wherein each POSS molecule is linked to a respective ethylene oxide molecule from the PEO-acrylate chain by a covalent bond formed with a macro-initiator molecule attached to the respective ethylene oxide molecule.

4. The polymer electrolyte of claim 1, wherein an ionic conductivity of the polymer electrolyte is based, at least in part, on a ratio of moles of salt molecules to moles of ethylene oxide molecules.

5. The polymer electrolyte of claim 2, wherein each of the plurality of macro-initiator molecules acts as an initiator to allow a POSS molecule to form a covalent bond with it during a polymerization process.

6. The polymer electrolyte of claim 1, wherein the plurality of ethylene oxide molecules has a concentration of 1-300 kilograms per mole (kg/mol) and the plurality of POSS molecules has a concentration of 1-300 kg/mol.

7. The polymer electrolyte of claim 1, wherein the salt molecules comprise lithium bi sulfonamide (LiTFSI) salt molecules.

8. A method comprising:
combining a poly ethylene oxide (PEO)-acrylate chain including a plurality of ethylene oxide molecules with macro-initiator molecules, thereby forming a PEO-based macro-initiator chain;
radically polymerizing a plurality of polyhedral oligomeric silsesquioxane (POSS)-acryloisobutyl monomers using the PEO-based macro-initiator chain as an initiator, thereby forming a block copolymer; and
adding a plurality of salt molecules to the block copolymer to form a polymer electrolyte.

9. The method of claim 8, wherein an ionic conductivity of the polymer electrolyte is based, at least in part, on a ratio of moles of salt molecules to moles of ethylene oxide molecules.

10. The method of claim 8, wherein the PEO-acrylate chain is reacted with the macro-initiator molecules in an anhydrous organic solvent at a temperature between 90 to 105 degrees Celsius and under Argon for 2 to 12 hours.

11. The method of claim 8, wherein the POSS molecules are polymerized in an anhydrous organic solvent at a temperature between 90 to 125 degrees Celsius for 2 hours to 5 days.

12. The method of claim 11, further comprising isolating the block copolymer, wherein isolating the block copolymer comprises:
precipitating the block copolymer in an organic solvent; and
subjecting the block copolymer to centrifugation at 1000 to 10000 revolutions per minute (RPM) for 2 to 30 minutes.

13. The method of claim 10, further comprising isolating the PEO-based macro-initiator chain, wherein the isolating comprises precipitating the PEO-based macro-initiator chain in an organic solvent.

14. A battery comprising:
an anode;
a cathode;
a polymer electrolyte configured to carry current between the anode and the cathode, wherein the polymer electrolyte comprises:
a poly ethylene oxide (PEO)-acrylate chain comprising a plurality of ethylene oxide molecules;
a polyhedral oligomeric silsesquioxane (POSS) chain comprising a plurality of POSS molecules, wherein each of the plurality of POSS molecules is linked to a respective ethylene oxide molecule from the PEO-acrylate chain, thereby forming a block copolymer; and
a plurality of salt molecules.

15. The battery of claim 14, wherein the polymer electrolyte further comprises:
a macro-initiator chain comprising a plurality of macro-initiator molecules, wherein each of the plurality of ethylene oxide molecules is attached to a respective macro-initiator molecule via an acrylate functional group of the ethylene oxide molecule.

16. The battery of claim 15, wherein each POSS molecule is linked to a respective ethylene oxide molecule from the PEO-acrylate chain by a covalent bond formed with a macro-initiator molecule attached to the respective ethylene oxide molecule.

17. The battery of claim 14, wherein an ionic conductivity of the polymer electrolyte is based, at least in part, on a ratio of moles of salt molecules to moles of ethylene oxide molecules.

18. The battery of claim 15, wherein each of the plurality of macro-initiator molecules acts as an initiator to allow a POSS molecule to form a covalent bond with it during a polymerization process.

19. The battery of claim 14, wherein the plurality of ethylene oxide molecules has a concentration of 1-50 kilograms per mole and the plurality of POSS molecules has a concentration of 1-50 kilograms per mole.

20. The battery of claim 14, wherein the salt molecules comprise lithium bi sulfonamide (LiTFSI) salt molecules.
